(19) United States
(12) Patent Application Publication
(10) Pub. No.: US 2025/0086035 A1
(43) Pub. Date: Mar. 13, 2025

(54) APPLICATION DATA PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventors: Yuan WU, Beijing (CN); Feihu YUAN, Beijing (CN)

(21) Appl. No.: 18/571,692

(22) PCT Filed: Nov. 20, 2023
(86) PCT No.: PCT/CN2023/132612

§ 371 Date: Dec. 18, 2023

(30) Foreign Application Priority Data
Dec. 12, 2022 (CN) 202211600079.2

(51) Int. Cl. G06F 9/54; G06F 16/178; G06F 21/60

(52) U.S. Cl. CPC G06F 9/543; G06F 16/178; G06F 21/602

(57) ABSTRACT

Embodiments of the present disclosure provides an application data processing method and apparatus, an electronic device and a storage medium. The method includes: acquiring target data in response to a data replication instruction for a first application in a target operating system, the first application is in data isolation with a second application in the target operating system; loading the target data to a system clipboard to generate a temporary file; and loading the temporary file by the second application to obtain the target data, and executing a target function corresponding to the second application based on the target data. Data transmission between different applications in a data isolation state is implemented without additional data storage process, and the data transmission efficiency and the storage space utilization rate are improved.

### CROSS-REFERENCE TO RELATED APPLICATION(S)

The present disclosure claims the priority to Chinese Patent Application No. 202211600079.2, filed on Dec. 12, 2022, and entitled “APPLICATION DATA PROCESSING METHOD, APPARATUS, ELECTRONIC DEVICE AND STORAGE MEDIUM”, the disclosures of which are incorporated herein by reference in its entirety.

### FIELD

Embodiments of the present disclosure relate to the technical field of the Internet, and in particular, to an application data processing method, an apparatus, an electronic device and a storage medium.

### BACKGROUND

At present, more and more applications (Application, APPs) are installed and operated in terminal devices. In some specific application scenarios, data transmission and interaction between different applications are required to implement collaborative works between the different applications.

In the prior art, data transmission between the different applications is usually implemented in a such a way that an application serving as a data output terminal saves data as a file for storage, and then an application serving as a data input terminal loads the file, so as to realize data transmission.

However, data transmission modes via data saving and loading have the problems, such as a low data transmission speed, occupation of the storage spaces of the terminal devices, etc.

### SUMMARY

Embodiments of the present disclosure provide an application data processing method, an apparatus, an electronic device and a storage medium, so as to overcome the problems of a low data transmission speed and occupation the storage space of a terminal device.

In a first aspect, an embodiment of the present disclosure provides an application data processing method, including:
acquiring target data in response to a data replication instruction for a first application in a target operating system, the first application is in data isolation with a second application in the target operating system; loading the target data to a system clipboard to generate a temporary file; and loading the temporary file by means of the second application, so as to obtain the target data, and executing a target function corresponding to the second application based on the target data.

In a second aspect, an embodiment of the present disclosure provides an application data processing apparatus, including:
a first functional module, configured to acquire target data in response to a data replication instruction for a first application in a target operating system, wherein the first application is in data isolation with a second application in the target operating system;
a clipboard module, configured to load the target data to a system clipboard to generate a temporary file; and
a second functional module, configured to load the temporary file by means of the second application to obtain the target data, and execute a target function corresponding to the second application based on the target data.

In a third aspect, an embodiment of the present disclosure provides an electronic device, including:
a processor, and a memory in communication connection with the processor;
the memory stores computer execution instructions; and
the processor executes the computer execution instructions stored in the memory, to implement the application data processing method in the first aspect and various possible designs of the first aspect.

In a fourth aspect, an embodiment of the present disclosure provides a computer-readable storage medium, wherein computer execution instructions are stored in the computer-readable storage medium, and the processor, when executes the computer execution instructions, implements the application data processing method in the first aspect and various possible designs of the first aspect.

In a fifth aspect, an embodiment of the present disclosure provides a computer program product, including a computer program, wherein the computer program, when being executed by a processor, implements the application data processing method in the first aspect and various possible designs of the first aspect.

According to the application data processing method and apparatus, the electronic device and the storage medium provided in the present embodiment, the target data is acquired in response to the data replication instruction for the first application in the target operating system, wherein the first application is in data isolation with the second application in the target operating system; the target data is loaded to the system clipboard to generate the temporary file; and the temporary file is loaded by means of the second application to obtain the target data, and the target function corresponding to the second application is executed based on the target data. After the target data of the first application is converted by using the system clipboard, the temporary file is generated, the temporary file is then loaded by means of the second application to restore a target file, such that data transmission between different applications in a data isolation state is implemented, no additional data storage process is required, and the data transmission efficiency and the storage space utilization rate are improved.

### BRIEF DESCRIPTION OF THE DRAWINGS

To illustrate technical solutions in the embodiments of the present disclosure or in the prior art more clearly, a brief introduction on the drawings which are needed in the description of the embodiments or the prior art is given below. Apparently, the drawings in the description below are merely some of the embodiments of the present disclosure, based on which other drawings may be obtained by those ordinary skilled in the art without any creative effort.

FIG. 1 is an application scenario diagram of an application data processing method provided according to an embodiment of the present disclosure;

FIG. 2 is a first schematic flowchart of an application data processing method provided according to an embodiment of the present disclosure;

FIG. 3 is a flowchart of a specific implementation of step S102 according to the embodiment shown in FIG. 2;

FIG. 4 is a schematic diagram of a process of merging target files provided according to an embodiment of the present disclosure;

FIG. 5 is a second schematic flowchart of an application data processing method provided according to an embodiment of the present disclosure;

FIG. 6 is a schematic diagram of a process of sequentially merging target files to generate a merged file provided according to an embodiment of the present disclosure;

FIG. 7 is a flowchart of a specific implementation of step S204 according to the embodiment shown in FIG. 5;

FIG. 8 is a schematic diagram of a process of encrypting a target file provided according to an embodiment of the present disclosure;

FIG. 9 is an execution flowchart of an application processing method provided according to an embodiment of the present disclosure;

FIG. 10 is a structural block diagram of an application data processing apparatus provided according to an embodiment of the present disclosure;

FIG. 11 is a schematic structural diagram of an electronic device provided according to an embodiment of the present disclosure; and

FIG. 12 is a schematic diagram of a hardware structure of an electronic device provided according to an embodiment of the present disclosure.

### DETAILED DESCRIPTION OF EMBODIMENTS

In order to make the objectives, technical solutions and advantages of the embodiments of the present disclosure clearer, a clear and complete description of the technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the present disclosure.

The application scenarios of the embodiments of the present disclosure are explained below:

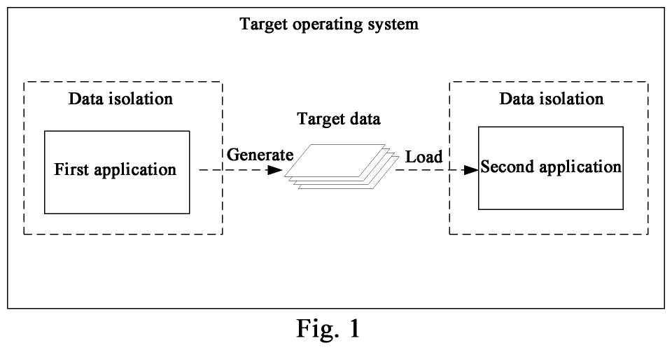

FIG. 1 is an application scenario diagram of an application data processing method provided according to an embodiment of the present disclosure. The application data processing method provided according to the embodiment of the present disclosure may be applied to a scenario in which data transmission is performed between different applications. More specifically, the method may be applied to data transmission between different applications in an IOS system. As shown in FIG. 1, the method provided according to the embodiment of the present disclosure may be applied to a terminal device, such as a smart phone, a personal computer, a tablet computer, and the like. A first application and a second application may run on a terminal device, wherein the first application is in data isolation with the second application. That is, data transmission may not be directly performed between the first application and the second application. More specifically, for example, the first application is a video editing program, and the second application is a video media program, such as a short video program. A user performs video editing by means of the first application on the basis of an original video. For example, the user may add a video sticker, add a video effect, and the like on the original video, and a corresponding video editing file, which is also referred to as an editing draft, is generated. The original video and the video editing file in FIG. 1 are collectively referred to as target data. Then, the terminal device runs the second application, loads, in the second application, the target data including the original video and the corresponding video editing file, and displays, on a second terminal device, video editing content which is represented by the original video and the corresponding video editing file. Then, based on a specific user instruction, the terminal device processes the target data by means of the second application. For example, the terminal may further edit the video, and uploads the further edited video to a short video platform.

In the prior art, for the design of security, the operating system isolates data in various applications from each other, for example, the first application may not access or read data generated in the second application, thereby ensuring data security of the user. In some related arts, the operating system may specifically set a channel for data transmission between applications. For example, in an IOS system, for applications issued by the same manufacturer, data transfer may be performed by means of a group mechanism in the IOS system, so as to implement the data transmission between two applications belonging to the same manufacturer. However, for applications of different manufacturers, an application serving as a data output terminal generally saves the data as a file for storage, and an application serving as a data input terminal loads the file, so as to implement data transmission. In the foregoing manner, the user needs to manually implement saving and loading operations, and meanwhile, the data saving and loading processes are time-consuming, so that rapid data transmission between different applications may not be implemented, resulting in the problems of a low data transmission speed and occupation of the storage space of the terminal device, and the like. The embodiment of the present disclosure provides an application data processing method to solve the above-mentioned problems.

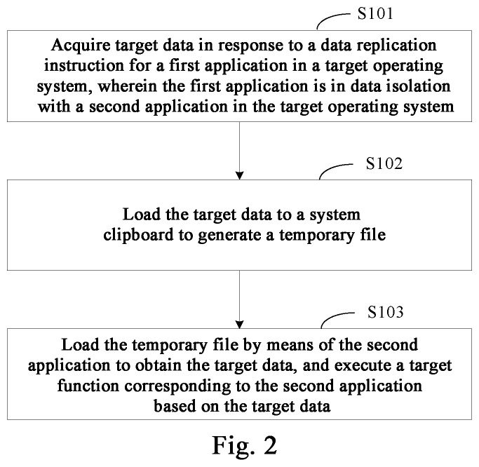

Referring to FIG. 2, FIG. 2 is a first schematic flowchart of an application data processing method provided according to an embodiment of the present disclosure. Exemplarily, the method according to the present embodiment may be applied to a terminal device, and the application data processing method includes:

Step S101: acquiring target data in response to a data replication instruction for a first application in a target operating system, wherein the first application is in data isolation with a second application in the target operating system.

Exemplarily, the target operating system is an IOS operating system, the terminal device is a device for running the IOS operating system, the first application is, for example, a video editing program. Based on the above exemplary application scenario, during the process of running the first application, the terminal device generates a corresponding data replication instruction for the first application after receiving a data replication operation input by the user, wherein the data replication instruction is used for saving target data generated during the process of running the first application. The target data is, for example, original video data, as well as editing data which is generated during the process of editing the original video data by means of the video editing program and represents editing content. More specifically, the editing data includes, for example, related information for describing content such as video effects, video stickers, background music and the like, which are added in the original video, and details are not described in detail. The acquisition of the target data may refer to determining a data address of the target data, for example, a uniform resource locator (URL).

There are multiple trigger modes for data replication instruction, for example, a save button (button) disposed in the first program is clicked to trigger the data replication instruction; or a target area in the first program is pressed for a long time to pop up a menu bar, and a save menu in the menu bar is clicked to trigger the data replication instruction. There generation mode of the data replication instruction is not specifically limited herein, and may be determined according to the specific design of the first application.

Step S102: loading the target data to a system clipboard to generate a temporary file.

Exemplarily, after the target data corresponding to the first application is obtained in response to the data replication instruction, data is packaged based on the data address of the target data to generate data with a specific format, and the data is loaded into the system clipboard, that is, the temporary file is generated. The system clipboard is a functional module, which is provided by the operating system for data caching, and which may be applied to data sharing between different applications, so as to achieve the purpose of data relay. Since the system clipboard is a system-level application, (in the case of authorization) which has the capability of accessing the data in the application, the data in the first application, for example, data address of the target data, may be obtained based on the system clipboard. Then, the data is loaded based on the data address, so that the target data is loaded to the system clipboard, and is saved as a temporary file in a target data format. The temporary file has the target data format, the target data format corresponds to the target operating system, and the specific implementation of the target data format is related to the specific implementation of the system clipboard in different operating systems, which is not specifically limited herein. It should be noted that, based on the specific implementation principle of the target operating system (e.g., the IOS operating system), the system clipboard may include multiple data channels, including a channel for transmitting character information (i.e., character strings), and a channel for transmitting file data such as videos and images. Since the target data needs to be transmitted, the system clipboard in the present embodiment specifically refers to a channel for transmitting file data in the system clipboard.

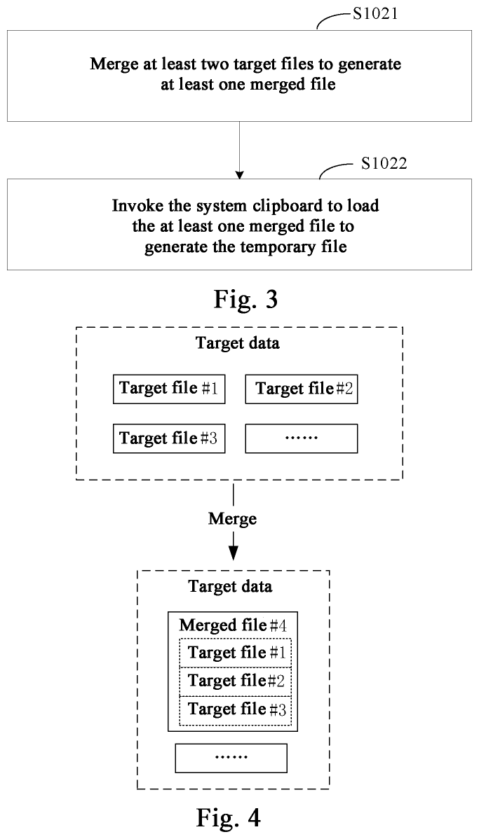

In a possible implementation, the target data may include at least two target files, and as shown in FIG. 3, the specific implementation steps of step S102 include:

Step S1021: merging at least two target files to generate at least one merged file.

Step S1022: invoking the system clipboard to load the at least one merged file to generate a temporary file.

Exemplarily, when the target data includes multiple target files, during the process of copying the target files by using the system clipboard, each target file needs to be sequentially processed, resulting in multiple times of file access. Such file access processes lead to additional calculation overheads, thereby increasing the time consumption. FIG. 4 is a schematic diagram of a process of merging target files provided according to an embodiment of the present disclosure. As shown in FIG. 4, in the target operating system, target files output by the first application includes a target file #1, a target file #2 and a target file #3. Exemplarily, the target file #1, the target file #2 and the target file #3 may be merged to generate a merged file #4, and then the system clipboard is invoked to load and store the target file #4, so as to generate a corresponding temporary file.

In the present embodiment, target files with small data lengths are merged to generate a merged file with a greater data length for loading, so that a number of times for reading target files by the terminal device may be reduced, thereby the file processing efficiency under a multi-target file condition may be improved, and the time consumption may be reduced.

In a possible implementation, specific implementation of step S1021 includes:
acquiring file information of at least two target files, wherein the file information includes storage addresses of the target files; and performing logical address merging based on the storage addresses corresponding to the at least two target files to obtain merged file information, wherein the merged file information represents a storage address of the merged file. Based on the implementation of the step S1021, correspondingly, the implementation of the step S1022 includes: invoking the system clipboard to perform file loading process based on the merged file information to generate the temporary file.

Specifically, during the process of generating the merged file, the merged file may be determined by means of the file information of the target files, and the file information indicates storage addresses (URL) of the target files. In a possible implementation, in combination with the embodiment shown in FIG. 4, the process of generating the merged file may be implemented by means of file information corresponding to the target file #1, the target file #2 and the target file #3 respectively. For example, the file information includes file sizes and storage addresses of the target files. The file sizes of the target file #1, the target file #2 and the target file #3 are determined according to the file information of the target file #1, the target file #2 and the target file #3. After the file sizes are determined, if a merging requirement is met, logical splicing is performed on the target file #1, the target file #2 and the target file #3 according to the storage addresses of the target file #1, the target file #2 and the target file #3, so as to obtain file information for describing storage address of a continuous splicing result of the target file #1, the target file #2 and the target file #3, that is, merged file information. The storage address of the merged file is obtained by means of the merged file information. Then, the system clipboard is configured to perform load process based on the merged file information, and then the temporary file may be generated in the system clipboard.

In the present embodiment, by means of acquiring the storage addresses of the target files, performing logical address splicing based on the storage addresses of the target files, so as to obtain the merged file information for indicating a storage address of the merged file, and invoking the system clipboard to perform data loading process based on the merged file information, before storing the target files into the system clipboard, it is only necessary to perform logical processing on the target files without performing physical copy on the target files, thereby the overall processing speed of the target data is improved.

Step S103: loading the temporary file by means of the second application to obtain the target data, and executing a target function corresponding to the second application based on the target data.

Exemplarily, after loading the target data and generating the temporary file in the system clipboard, the terminal device reads the system clipboard by means of the running second application, so as to obtain the temporary file stored in the system clipboard and loads the temporary file. Then, based on a specific generation mode of the temporary file, the terminal device restores the temporary file by means of the second application and to obtain the target data corresponding to the temporary file, that is, data output by the first application. Therefore, the transmission of the target data from the first application to the second application may be implemented.

The event that the second application loads the temporary file to obtain the target data may be triggered in many cases. In one possible implementation, the event that the second application loads the temporary file to obtain the target data is triggered in response to the foreground program running of the second application. Specifically, for example, during the process of running the first application, the terminal device generates the temporary file in the system clipboard by means of performing the steps in the above embodiment. Then, when the terminal device starts the second application or switches the second application to a foreground (activated) page, the terminal device automatically detects the information in the system clipboard to obtain the temporary file and loads the temporary file. In another possible implementation, the event in which the second application loads the temporary file to obtain the target data is triggered in response to a user operation. For example, specifically, during the process of running the first application, the terminal device generates the temporary file in the system clipboard by means of performing the steps in the above embodiment. Then, after starting the second application, the terminal device generates and executes a corresponding data pasting instruction in response to the user operation (for example, the user clicks a control which is disposed in the interface of the second application and is used for pasting a target file), reads the information in the system clipboard, to obtain the temporary file, and loads the temporary file.

Further, exemplarily, after obtaining the target data, the second application implements a corresponding target function based on a target program, for example, further processing of the target data, display of digital-analog data, uploading of the target data, and the like. More specifically, for example, the target data includes a media file (a type of target file) and an editing file (another type of target file) corresponding to the media file, and the editing file represents content for editing the media file. For example, the media file is a video file. After obtaining the target data by means of the temporary file, the second application displays the video file and editing content corresponding to the video file, for example, effect information (including a position of effect, a type of effect or the like) of each frame in the video file, a timestamp of each frame, a background music corresponding to the video file, and the like. Therefore, the second application may perform further editing and display according to the data output by the first application, for example, a video editing draft or an engineering file, and meanwhile, the efficiency and speed of data transmission are improved.

In the present embodiment, the target data is acquired in a target operating system in response to the data replication instruction for the first application, wherein the first application is in data isolation with the second application in the target operating system; the target data is loaded to the system clipboard, so as to generate the temporary file; and the temporary file is loaded by means of the second application to obtain the target data, and the target function corresponding to the second application is executed based on the target data. After the target data of the first application is converted by using the system clipboard, the temporary file is generated, the temporary file is then loaded by means of the second application to restore a target file, such that data transmission between different applications in a data isolation state is implemented without any additional data storage process, and the data transmission efficiency and the storage space utilization rate are improved.

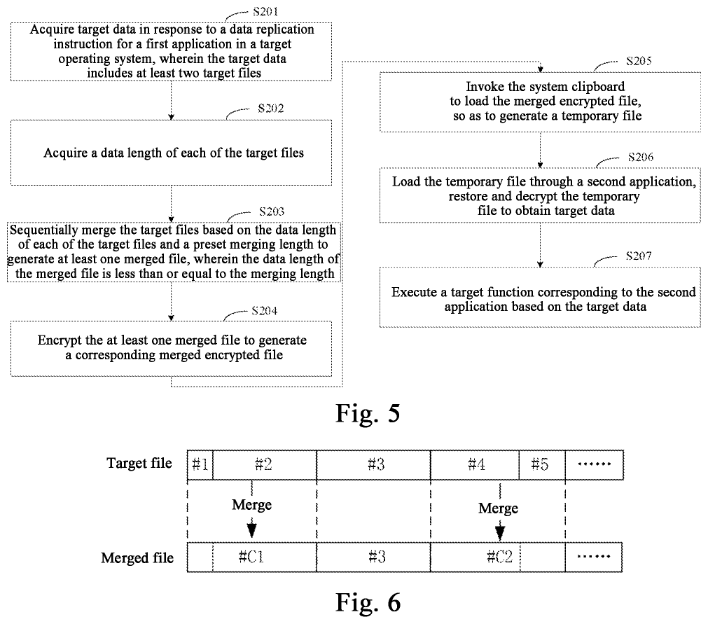

Referring to FIG. 5, FIG. 5 is a second schematic flowchart of an application data processing method provided according to an embodiment of the present disclosure. In the present embodiment, based on the embodiment shown in FIG. 2, steps S102 and S103 are further refined, and the application data processing method includes:

Step S201: acquiring target data in response to a data replication instruction for a first application in a target operating system, wherein the target data includes at least two target files.

Step S202: acquiring a data length of each the target file.

Step S203: sequentially merging each of the target files based on the data length of each of the target files and a preset merging length, so as to generate at least one merged file, wherein a data length of the merged file is less than or equal to the merging length.

Exemplarily, target data may be a folder containing multiple target files, and the multiple target files in the folder have different data lengths, that is, file sizes. For example, a data length of the target file #1 is 1 mega byte (MB), and a data length of the target file #2 is 3 mega bytes (MB). A specific data length value of the target file may be obtained by means of the file information of the target file, the specific implementation may refer to related description in step S102 in the embodiment shown in FIG. 2, and thus details are not described herein again. Then, based on the data length of each target file and the preset merging length, the target files are sequentially merged to obtain multiple merged files. A data length of a merged file is limited by the preset merging length, that is, less than or equal to the preset merging length.

FIG. 6 is a schematic diagram of a process of sequentially merging the target files to generate a merged file provided according to an embodiment of the present disclosure. As shown in FIG. 6, target data includes multiple sequentially arranged target files, which specifically include a target file #1 (shown as #1 in the figure, the same below), a target file #2, a target file #3, a target file #4, and a target file #5, wherein the preset merging length is 8 (a preset unit, for example, Mb, the same below). Then, in combination with data lengths of the target files, for example, a data length of the target file #1 is 1, a data length of the target file #2 is 5, a data length of the target file #3 is 6, a data length of the target file #4 is 4, and a data length of the target file #5 is 2, therefore, the target file #1 and the target file #2 are merged to form a merged file #C1 (shown as #C1 in the figure, the same below); and the target file #4 and the target file #5 are merged to form a merged file #C2, and the target file #3 is not merged. Of course, it can be understood that, based on a data length of a target file (e.g., a target file #6) subsequent to the target file #5, it is possible to merge the target file #4, the target file #5 and the target file #6 to form a merged file, or it is possible to merge the target file #6 with another target file to form a merged file, the specific conditions are not described in detail again.

The process of combining the target files to generate the merged file may be implemented in a logical address merging manner based on file information of each of the target files. The specific implementation may be referred to the detailed description in step S102 according to embodiment shown in FIG. 2, thus details are not described herein again.

During the process of processing the target files by the terminal device, on one hand, after segmented files with small data lengths are combined, a number of times for reading the files is effectively reduced and the efficiency of generating the temporary file by the system clipboard is improved; on the other hand, when a data length of the generated synthesized file is too large, a part of the synthesized files may be encrypted after all the synthesized files are loaded during a subsequent process of encrypting the synthesized files, thereby affecting the efficiency of encrypting the synthesized files, and thus reducing the overall transmission efficiency of the target data and increasing the time consumption. Therefore, in an embodiment of the present application, while the target files with the small data lengths are combined, the data length of the generated merged file is limited to avoid the occurrence a synthesized file with an overlarge volume, which may reduce the efficiency in the subsequent encryption process, such that the overall transmission efficiency of the target data is improved.

Step S204: encrypting the at least one merged file to generate a corresponding merged encrypted file.

For example, during the process of performing data transmission based on the system clipboard, any authorized application may read the content in the system clipboard. For example, after the temporary file is generated in the system clipboard by the first application based on the above steps, a third application is executed, and herein, the third application may obtain the temporary file by reading the content in the clipboard, resulting in security problems such as data leakage. Therefore, in the embodiment of the present disclosure, after the merged file is obtained, the merged file is encrypted at first, and then the temporary file is generated. After the second application obtains the temporary file, the content of the corresponding merged file may be obtained only after corresponding decryption is performed by using a key, thereby ensuring data security.

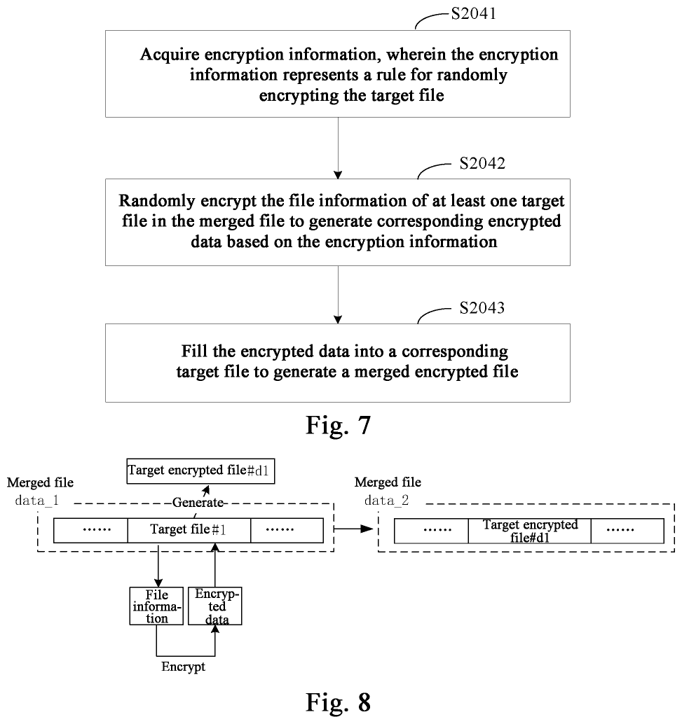

In a possible implementation, as shown in FIG. 7, the specific implementation of step S204 includes:

Step S2041: acquiring encryption information, and the encryption information represents a rule for randomly encrypting the target files.

Step S2042: randomly encrypting the file information of at least one target file in the merged file to generate corresponding encrypted data based on the encryption information.

Step S2043: filling the encrypted data into a corresponding target file to generate the merged encrypted file.

For example, the merged file is generated by combining the at least two target files, therefore, the merged file contains the at least two target files. During the process of encrypting the merged file, in one possible implementation, the merged file may be integrally encrypted, so as to obtain a better encryption effect and improve the encryption security. In another possible implementation, one or more target files in one merged file may be selectively and dynamically encrypted, thereby reducing the amount of data encryption and improving the speed of data encryption.

More specifically, for example, the encryption information representing the random encryption rule is obtained at first, and which target file(s) is encrypted may be determined by means of the encryption information. More specifically, the encryption information includes information such as a number and positions of the target files that need to be randomly encrypted, and/or a specific encryption algorithm and a key used. After the file information of the target files is randomly encrypted based on the encryption information, corresponding encrypted data is generated. Since the file information includes information such as a data storage address, after the file information is encrypted, the target file(s) may be protected. Then, the encrypted data is filled into a corresponding target file to generate the encrypted file.

FIG. 8 is a schematic diagram of a process of encrypting a target file provided according to an embodiment of the present disclosure. As shown in FIG. 8, first, based on the encryption information, it is determined to encrypt a target file #1 in a merged file data_1. Then, the file information of the target file #1 is obtained. An encrypted segment displacement is generated based on a key provided by the encryption information. Some or all information in the file information is encrypted based on the encrypted segment displacement to generate the encrypted data. Next, the encrypted data is filled back into the target file #1, so that the target file #1 may generate an encrypted target file #dl, therefore, the data in the merged file data_1 is updated, which is equivalent to generating a new merged file data_2, and the merged file data_2 is a merged encrypted file.

In the present embodiment, by means of encrypting the segments of a small number of target files in the merged file, on one hand, the amount of data encryption may be reduced, and the encryption efficiency may be improved; and on the other hand, a number of target files needing to be encrypted is reduced, therefore when decryption is performed by means of the second application, the corresponding decryption time consumption is also reduced, thereby improving the data transmission efficiency and reducing the time consumption while the transmission security of the target data is ensured.

Further, in an embodiment of the present disclosure, the encryption information may be preset fixed encryption information. Alternatively, the encryption information may also be dynamically determined based on a data length of a target file. In a possible implementation, before S204, the method further includes:
Step S2040a: acquiring a first data length of at least one target file and a preset second data length;
step S2040b: calculating a first encryption number of times required for encrypting the first data length and a second encryption number of times required for encrypting the second data length;
step S2040c: determining a smaller one of the first encryption number of times and the second encryption number of times to be a target encryption number of times, and generating the encryption information based on the target encryption number of times.

For example, for a specific target file, the first data length is the actual data length of the target file, for example, 1 Gb, and the second data length is a preset data length, which may be a reasonable data segment length that is set based on experience, for example, 1 Mb. Generally, when the data is uniformly encrypted, the greater the data length is, the greater the encryption number of times is. For example, based on a preset data length threshold value, for example, 1024 Kb, the first encryption number of times corresponding to the first data length is 1000,000 times, and the second encryption number of times corresponding to the second data length is 1,000 times. Afterwards, the smaller one of the first encryption number of times and the second encryption number of times is used as the target encryption number of times, for example, the second encryption number of times (1,000 times) in the above example. The target file may be uniformly encrypted by means of the above encryption number of times, that is, an encryption position of the target file is determined, so as to generate the encryption information. In an embodiment of the present disclosure, by means of the second data length which is set based on experience, the data length of the encrypted target data is limited to be at a relatively low level. If the first data length of the target data is less than a preset empirical value, the first data length is adaptively determined to be the target number of times for encryption, so as to ensure that the data length of the encrypted file is relatively low, thereby improving the encryption speed, and reducing the time consumption of the encryption process.

Step S205: invoking the system clipboard to load the merged encrypted file to generate a temporary file.

Step S206: loading the temporary file by means of the second application, and restoring and decrypting the temporary file to obtain target data.

For example, after the merged encrypted file is obtained, encoding is performed in combination with the unencrypted combined file obtained in the above steps and a target file which is not combined into the combined file to generate the corresponding temporary file, and the temporary file is generated in the system clipboard. The target data format of the temporary file is determined by an encoding rule, and details are not described in detail. Then, after the second application runs, the second application reads the system clipboard based on a manual or an automatic trigger mode, obtains the temporary file in the clipboard, and restores and decrypts the temporary file, wherein the rule for restoring the temporary file is determined based on the encoding rule and is preset in the second application; the rule for decrypting the temporary file may be sent by the first application to the second application before or after an encryption step (e.g., after step S204) is performed. More specifically, for example, after the step S204, the encryption information is sent to the second application. In a possible implementation, the specific implementation of step S206 includes:

Step S2061: reading the system clipboard to obtain the temporary file, when the second application runs in the foreground.

Step S2062: acquiring the encrypted file corresponding to the temporary file, and restoring the temporary file based on the encrypted file to obtain the target data.

For example, after the temporary file is generated in the system clipboard, when the second application is switched to run in the foreground, the second application automatically reads the content in the system clipboard to obtain the temporary file. Then the second application decrypts and restores the encrypted file based on the encryption information obtained in the previous step, so as to obtain the target file corresponding to the temporary file, that is, the file output by the first application. The process of decrypting and restoring the temporary file has been described in the embodiment shown in FIG. 2, and thus details are omitted herein.

Step S207: executing a target function corresponding to the second application based on the target data.

In the present embodiment, the specific implementations of steps S201 and S207 are consistent with the implementations of the corresponding steps in steps S101 and S103 in the embodiment shown in FIG. 2, specific discussion may be referred to the specific description in the above embodiments, and thus details are omitted herein.

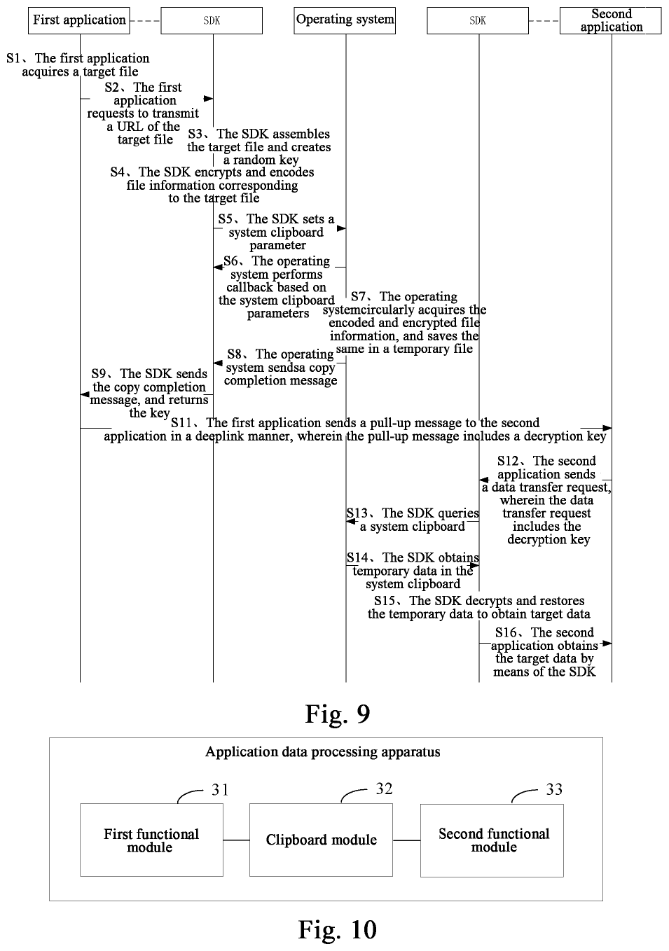

In order to better describe the application data processing method provided in the present embodiment, an implementation process of the method is described below in a more specific embodiment. FIG. 9 is an execution flowchart of an application processing method provided according to an embodiment of the present disclosure. Referring to FIG. 9, the application data processing provided in the present embodiment may be implemented by a software development kit (SDK) installed in an application, the first application and the second application are installed with the SDK for implementing the application data processing method described in the above embodiments, and specifically, the application data processing method includes:

S1: a first application acquires a target file.

S2: the first application requests to transmit the URL of the target file.

S3: an SDK assembles the target file and creates a random key.

S4: the SDK encrypts and encodes file information corresponding to the target file. S5: the SDK sets system clipboard parameters.

S6: an operating system performs callback based on the system clipboard parameters.

S7: the operating system circularly acquires the encoded and encrypted file information, and saves the same in a temporary file.

S8: the operating system sends a copy completion message.

S9: the SDK sends the copy completion message, and returns the key.

S10: the first application displays prompt information.

S11: the first application sends a pull-up message to a second application in a deeplink (deeplink) manner, and the pull-up message includes a decryption key.

S12: the second application sends a data transfer request, and the data transfer request includes the decryption key.

S13: the SDK queries a system clipboard.

S14: the SDK obtains temporary data in the system clipboard.

S15: the SDK decrypts and restores the temporary data to obtain target data.

S16: the second application obtains the target data by means of the SDK.

Corresponding to the application data processing method in the above embodiment, FIG. 10 is a structural block diagram of an application data processing apparatus provided according to an embodiment of the present disclosure. For ease of description, only parts related to embodiments of the present disclosure are shown. Referring to FIG. 10, the application data processing apparatus 3 includes:
a first functional module 31, configured to acquire target data in response to a data replication instruction for a first application in a target operating system, wherein the first application is in data isolation with a second application in the target operating system;
a clipboard module 32, configured to load the target data to a system clipboard, to generate a temporary file; and
a second functional module 33, configured to load the temporary file by means of the second application to obtain the target data, and perform a target function corresponding to the second application based on the target data.

In an embodiment of the present disclosure, the target data includes at least two target files; the clipboard module 32 is specifically configured to: merge the at least two target files to generate at least one merged file; and invoke the system clipboard to load the at least one merged file to generate the temporary file.

In an embodiment of the present disclosure, when merging the at least two target files to generate the at least one merged file, the clipboard module 32 is specifically configured to: acquire file information of the at least two target files, the file information includes storage addresses of the target files; perform logical address merging based on the storage addresses corresponding to the at least two target files, to obtain merged file information, wherein the merged file information represents a storage address of the merged file. When invoking the system clipboard to load the at least one merged file to generate the temporary file, the clipboard module 32 is specifically configured to: invoke the system clipboard to perform file loading process based on the merged file information to generate the temporary file.

In an embodiment of the present disclosure, when merging the at least two target files to generate the at least one merged file, the clipboard module 32 is specifically configured to: acquire a data length of each of the target files; and sequentially merge the target files based on the data length of each of the target files and a preset merging length, so as to generate the at least one merged file, wherein the data length of the merged file is less than or equal to the merging length.

In an embodiment of the present disclosure, a target file includes a media file and an editing file corresponding to the media file, and the editing file represents content for editing the media file.

In an embodiment of the present disclosure, when merging the at least two target files to generate the at least one merged file, the clipboard module 32 is specifically configured to: encrypt at least one target file to generate a corresponding encrypted file; and generate a corresponding merged file based on the encrypted file.

In an embodiment of the present disclosure, when encrypting the at least one target file to generate the corresponding encrypted file, the clipboard module 32 is specifically configured to: acquire encryption information, the encryption information represents a rule for randomly encrypting the target file; randomly encrypt the file information of the at least one target file to generate corresponding encrypted data based on the encryption information; and fill the encrypted data into a corresponding target file to generate the encrypted file.

In an embodiment of the present disclosure, before implementing a step of following: randomly encrypting the at least one target file to generate the corresponding encrypted file based on the encryption information, the clipboard module 32 is further configured to: acquire a first data length of the at least one target file and a preset second data length; calculate a first encryption number of times required for encrypting the first data length and a second encryption number of times required for encrypting the second data length; and determine a smaller one of the first encryption number of times and the second encryption number of times to be a target encryption number of times, and generate the encryption information based on the target encryption number of times.

In an embodiment of the present disclosure, after implementing the step of randomly encrypting the at least one target file to generate the corresponding encrypted file based on the encryption information, the clipboard module 32 is further configured to: send the encryption information to the second application; and when generating the corresponding merged file based on the encrypted file, the clipboard module 32 is specifically configured to: combine the encrypted file with another unencrypted target files to generate the merged file.

In an embodiment of the present disclosure, the second functional module 33 is specifically configured to: when the second application runs in the foreground, read the system clipboard to obtain the temporary file; and acquire the encrypted file corresponding to the temporary file, and restore the temporary file based on the encrypted file, so as to obtain the target data.

The first functional module 31, the clipboard module 32 and the second functional module 33 are connected in sequence. The application data processing apparatus 3 provided in the present embodiment may execute the technical solutions of the above method embodiments, and the implementation principles and technical effects thereof are similar, thus details are not described in the present embodiment again.

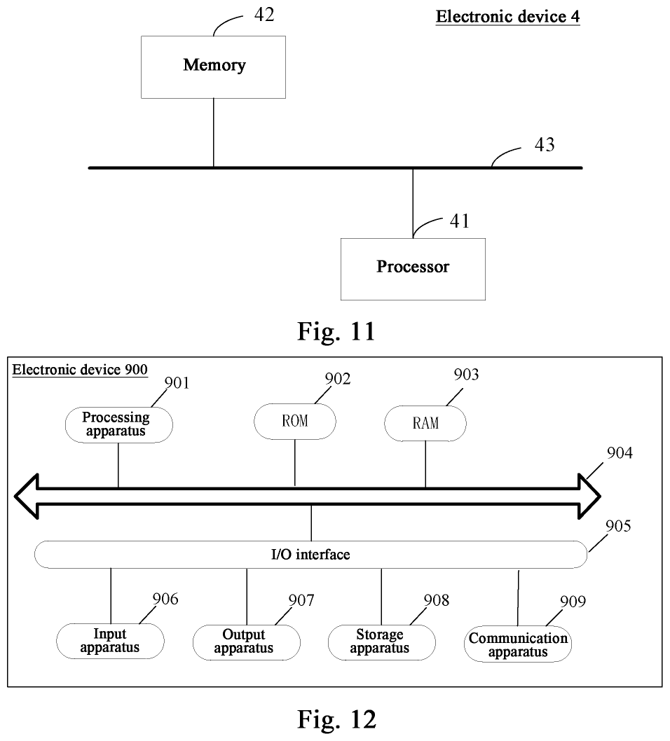

FIG. 11 is a schematic structural diagram of an electronic device provided in an embodiment of the present disclosure. As shown in FIG. 11, the electronic device 4 includes:
a processor 41, and a memory 42 in communication connection with the processor 41;
the memory 42 stores computer execution instructions; and
the processor 41 executes the computer execution instructions stored in the memory 42, to implement the application data processing method in the embodiments shown in FIG. 2 to FIG. 9.

Optionally, the processor 41 and the memory 42 are connected via a bus 43.

Related illustration may refer to related descriptions and effects corresponding to the steps in the embodiments corresponding to FIG. 2 to FIG. 9 for understanding, and thus details are not described herein.

Referring to FIG. 12, it illustrates a schematic structural diagram of an electronic device 900 suitable for implementing embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a portable Android device (PAD), a portable media player (PMP), a vehicle-mounted terminal (e.g., a vehicle-mounted navigation terminal), and the like, and a fixed terminal such as a digital TV, a desktop computer, and the like. The electronic device shown in FIG. 12 is merely an example, and should not bring any limitation to the functions and use ranges of the embodiments of the present disclosure.

As shown in FIG. 12, the electronic device 900 may include a processing apparatus (e.g., a central processing unit, a graphics processing unit, or the like) 901, which may perform various suitable actions and processes in accordance with a program stored in a read only memory (ROM for short) 902 or a program loaded from a storage apparatus 908 into a random access memory (RAM for short) 903. In the RAM 903, various programs and data needed by operations of the electronic device 900 are also stored. The processing apparatus 901, the ROM 902 and the RAM 903 are connected to each other via a bus 904. An input/output (I/O) interface 905 is also connected to the bus 904.

In general, the following apparatuses may be connected to the I/O interface 905: an input apparatus 906, including, for example, a touch screen, a touch pad, a keyboard, a mouse, a camera, a microphone, an accelerometer, a gyroscope, and the like; an output apparatus 907, including, for example, a liquid crystal display (LCD for short), a speaker, a vibrator, and the like; a storage apparatus 908, including, for example, a magnetic tape, a hard disk, and the like; and a communication apparatus 909. The communication apparatus 909 may allow the electronic device 900 to communicate in a wireless or wired manner with other devices to exchange data. While FIG. 12 illustrates the electronic device 900 having various apparatuses, it is to be understood that not all illustrated apparatuses are required to be implemented or provided. More or fewer apparatuses may alternatively be implemented or provided.

In particular, according to embodiments of the present disclosure, the processes described above with reference to flowcharts may be implemented as computer software programs. For example, embodiments of the present disclosure include a computer program product, which includes a computer program carried on a computer-readable medium, and the computer program contains program codes for performing the method illustrated in the flowcharts. In such embodiments, the computer program may be downloaded and installed from a network via the communication apparatus 909, or installed from the storage apparatus 908, or installed from the ROM 902. When the computer program is executed by the processing apparatus 901, the above functions defined in the method of the embodiments of the present disclosure are performed.

It should be noted that, the computer-readable medium described above in the present disclosure may be either a computer-readable signal medium or a computer-readable storage medium, or any combination of the two. The computer-readable storage medium may be, for example, but is not limited to, an electronic, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk-read-only memory (CD-ROM), an optical storage device, a magnetic storage device, or any suitable combination of the above. In the present disclosure, the computer-readable storage medium may be any tangible medium that contains or stores a program, wherein the program may be used by or in conjunction with an instruction execution system, apparatus or device. In the present disclosure, the computer-readable signal medium may include a data signal that is included in a baseband or is propagated as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in conjunction with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

The computer-readable medium may be contained in the above electronic device; or it may also be present separately and is not assembled into the electronic device.

The computer-readable medium carries one or more programs that, when being executed by the electronic device, cause the electronic device to execute the method shown in the above embodiments.

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including a local area network (LAN for short) or a wide area network (WAN for short), or it may be connected to an external computer (e.g., through the Internet using an Internet service provider).

The flowcharts and block diagrams in the drawings illustrate the system architecture, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions noted in the block may occur out of the order noted in the drawings. For example, two blocks shown in succession may, in fact, be executed substantially concurrently, or the blocks may sometimes be executed in a reverse order, depending upon the functions involved. It should also be noted that each block of the block diagrams and/or flowcharts, and combinations of the blocks in the block diagrams and/or flowcharts may be implemented by dedicated hardware-based systems for performing specified functions or operations, or combinations of dedicated hardware and computer instructions.

The units involved in the described embodiments of the present disclosure may be implemented in a software or hardware manner. The names of the units do not constitute limitations of the units themselves in a certain case. For example, a first acquisition unit may also be described as “a unit for acquiring at least two Internet Protocol addresses”.

The functions described herein above may be performed, at least in part, by one or more hardware logic components. For example, without limitation, example types of the hardware logic components that may be used include: field programmable gate arrays (FPGAs), application-specific integrated circuits (ASICs), application-specific standard products (ASSPs), system on chips (SOCs), complex programmable logic devices (CPLDs), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a compact disc-read-only memory (CD-ROM), an optical storage device, a magnetic storage device, or any suitable combination thereof.

In a first aspect, according to one or more embodiments of the present disclosure, an application data processing method is provided, the method may include:
acquiring target data in response to a data replication instruction for a first application in a target operating system, the first application is in data isolation with a second application in the target operating system; loading the target data to a system clipboard to generate a temporary file; and loading the temporary file by means of the second application, to obtain the target data, and executing a target function corresponding to the second application based on the target data.

According to one or more embodiments of the present disclosure, the target data includes at least two target files; the step of loading the target data to the system clipboard to generate the temporary file includes: merging the at least two target files to generate at least one merged file; and invoking the system clipboard to load the at least one merged file, to generate the temporary file.

According to one or more embodiments of the present disclosure, the step of merging the at least two target files to generate the at least one merged file includes: acquiring file information of the at least two target files, the file information includes storage addresses of the target files; performing logical address merging based on the storage addresses corresponding to the at least two target files, to obtain merged file information, wherein the merged file information represents a storage address of the merged file; and the step of invoking the system clipboard to load the at least one merged file to generate the temporary file includes: invoking the system clipboard to perform file loading process based on the merged file information, to generate the temporary file.

According to one or more embodiments of the present disclosure, the step of merging the at least two target files to generate the at least one merged file includes: acquiring a data length of each of the target file; and sequentially merging the target files based on the data length of each of the target file and a preset merging length, to generate the at least one merged file, wherein the data length of the merged file is less than or equal to the merging length.

According to one or more embodiments of the present disclosure, a target file includes a media file and an editing file corresponding to the media file, and the editing file represents content for editing the media file.

According to one or more embodiments of the present disclosure, the step of merging the at least two target files to generate the at least one merged file includes: encrypting at least one target file to generate a corresponding encrypted file; and generating the corresponding merged file based on the encrypted file.

According to one or more embodiments of the present disclosure, the step of encrypting the at least one target file to generate the corresponding encrypted file includes: acquiring encryption information, the encryption information represents a rule for randomly encrypting the target file; randomly encrypting the file information of the at least one target file based on the encryption information, to generate corresponding encrypted data; and filling the encrypted data into a corresponding target file to generate the encrypted file.

According to one or more embodiments of the present disclosure, before the step of randomly encrypting the at least one target file based on the encryption information to generate the corresponding encrypted file, the method further includes: acquiring a first data length of the at least one target file and a preset second data length; calculating a first encryption number of times required for encrypting the first data length and a second encryption number of times required for encrypting the second data length; and determining a smaller one of the first encryption number of times and the second encryption number of times to be a target encryption number of times, and generating the encryption information based on the target encryption number of times.

According to one or more embodiments of the present disclosure, after the step of randomly encrypting the at least one target file to generate the corresponding encrypted file based on the encryption information, the method further includes: sending the encryption information to the second application; and the step of generating the corresponding merged file based on the encrypted file includes: combining the encrypted file with other unencrypted target files to generate the merged file.

According to one or more embodiments of the present disclosure, the step of loading the temporary file by means of the second application to obtain the target data includes: when the second application runs in the foreground, reading the system clipboard to obtain the temporary file; acquiring the encrypted file corresponding to the temporary file, and restoring the temporary file based on the encrypted file to obtain the target data.

In a second aspect, according to one or more embodiments of the present disclosure, an application data processing apparatus is provided, including:
a first functional module, configured to acquire target data in response to a data replication instruction for a first application in a target operating system, the first application is in data isolation with a second application in the target operating system;
a clipboard module, configured to load the target data to a system clipboard to generate a temporary file; and
a second functional module, configured to load the temporary file by means of the second application to obtain the target data, and execute a target function corresponding to the second application based on the target data.

According to one or more embodiments of the present disclosure, the target data includes at least two target files; the clipboard module is specifically configured to: merge the at least two target files to generate at least one merged file; and invoke the system clipboard to load the at least one merged file to generate the temporary file.

According to one or more embodiments of the present disclosure, when merging the at least two target files to generate the at least one merged file, the clipboard module is specifically configured to: acquire file information of the at least two target files, the file information includes storage addresses of the target files; perform logical address merging based on the storage addresses corresponding to the at least two target files to obtain merged file information, wherein the merged file information represents a storage address of the merged file; and when invoking the system clipboard to load the at least one merged file to generate the temporary file, the clipboard module 32 is specifically configured to: invoke the system clipboard to perform file loading process based on the merged file information to generate the temporary file.

According to one or more embodiments of the present disclosure, when merging the at least two target files to generate the at least one merged file, the clipboard module is specifically configured to: acquire a data length of each of the target files; and sequentially merge the target files based on the data length of each of the target files and a preset merging length to generate the at least one merged file, wherein the data length of the merged file is less than or equal to the merging length.

According to one or more embodiments of the present disclosure, a target file includes a media file and an editing file corresponding to the media file, and the editing file represents content for editing the media file.

According to one or more embodiments of the present disclosure, when merging the at least two target files to generate the at least one merged file, the clipboard module is specifically configured to: encrypt at least one target file to generate a corresponding encrypted file; and generate the corresponding merged file based on the encrypted file.

According to one or more embodiments of the present disclosure, when encrypting the at least one target file to generate the corresponding encrypted file, the clipboard module is specifically configured to: acquire encryption information, the encryption information represents a rule for randomly encrypting the target file; randomly encrypt the file information of at least one target file to generate corresponding encrypted data based on the encryption information; and fill the encrypted data into a corresponding target file to generate the encrypted file.

According to one or more embodiments of the present disclosure, before implementing the step of randomly encrypting the at least one target file to generate the corresponding encrypted file based on the encryption information, the clipboard module is further configured to: acquire a first data length of the at least one target file and a preset second data length; calculate a first encryption number of times required for encrypting the first data length and a second encryption number of times required for encrypting the second data length; and determine a smaller one in the first encryption number of times and the second encryption number of times to be a target encryption number of times, and generate the encryption information based on the target encryption number of times.

According to one or more embodiments of the present disclosure, after implementing the step of randomly encrypting the at least one target file to generate the corresponding encrypted file based on the encryption information, the clipboard module is further configured to: send the encryption information to the second application; and when generating the corresponding merged file based on the encrypted file, the clipboard module is specifically configured to: combine the encrypted file with other unencrypted target files to generate the merged file.

According to one or more embodiments of the present disclosure, the second functional module is specifically configured to: when the second application runs in the foreground, read the system clipboard to obtain the temporary file; and acquire the encrypted file corresponding to the temporary file, and restore the temporary file based on the encrypted file to obtain the target data.

In a third aspect, according to one or more embodiments of the present disclosure, an electronic device is provided, including: a processor, and a memory in communication connection with the processor;
the memory stores computer execution instructions; and
the processor executes the computer execution instructions stored in the memory to implement the application data processing method in the first aspect and various possible designs of the first aspect.

In a fourth aspect, according to one or more embodiments of the present disclosure, a computer-readable storage medium is provided, computer execution instructions are stored in the computer-readable storage medium, and the processor, when executing the computer execution instructions, implements the application data processing method in the first aspect and various possible designs of the first aspect.

In a fifth aspect, an embodiment of the present disclosure provides a computer program product, including a computer program, the computer program, when being executed by a processor, implements the application data processing method in the first aspect and various possible designs of the first aspect.

What have been described above are only preferred embodiments of the present disclosure and illustrations of the technical principles employed. It will be appreciated by those skilled in the art that the scope of the present disclosure is not limited to the technical solutions formed by specific combinations of the above technical features, and meanwhile should also include other technical solutions formed by any combinations of the above technical features or equivalent features thereof, for example, technical solutions formed by mutual replacement of the above features with technical features having similar functions disclosed in the present disclosure (but is not limited to).

In addition, although operations are depicted in a particular order, this should not be understood as requiring that these operations are performed in the particular order shown or in a sequential order. In certain circumstances, multitasking and parallel processing may be advantageous. Similarly, although several specific implementation details have been contained in the above discussion, these should not be construed as limiting the scope of the present disclosure. Certain features that are described in the context of separate embodiments may also be implemented in combination in a single embodiment. Conversely, various features that are described in the context of a single embodiment may also be implemented in a plurality of embodiments separately or in any suitable sub-combination.

Although the present theme has been described in a language specific to structural features and/or methodological actions, it is to be understood that the present theme defined in the appended claims is not necessarily limited to the specific features or actions described above. Rather, the specific features and actions described above are merely example forms of implementing the claims.

1. An application data processing method, comprising:
acquiring target data in response to a data replication instruction for a first application in a target operating system, wherein the first application is in data isolation with a second application in the target operating system;
loading the target data to a system clipboard to generate a temporary file; and
loading the temporary file by means of the second application to obtain the target data, and executing a target function corresponding to the second application based on the target data.

2. The method according to claim 1, wherein the target data comprises at least two target files; the step of loading the target data to the system clipboard to generate the temporary file comprises:
merging the at least two target files to generate at least one merged file; and
invoking the system clipboard to load the at least one merged file to generate the temporary file.

3. The method according to claim 2, wherein the step of merging the at least two target files to generate the at least one merged file comprises:
acquiring file information of the at least two target files, wherein the file information comprises storage addresses of the target files;
performing logical address merging based on the storage addresses corresponding to the at least two target files to obtain merged file information, wherein the merged file information represents a storage address of the merged file; and
the step of invoking the system clipboard to load the at least one merged file to generate the temporary file comprises:
invoking the system clipboard to perform file loading process based on the merged file information to generate the temporary file.

4. The method according to claim 2, wherein the step of merging the at least two target files to generate the at least one merged file comprises:
acquiring a data length of each of the target files; and
sequentially merging the target files based on the data length of each of the target files and a preset merging length to generate the at least one merged file, wherein the data length of the merged file is less than or equal to the merging length.

5. The method according to claim 2, wherein a target file comprises a media file and an editing file corresponding to the media file, and the editing file represents content for editing the media file.

6. The method according to claim 2, wherein the step of merging the at least two target files to generate the at least one merged file comprises:
encrypting at least one target file to generate a corresponding encrypted file; and
generating the corresponding merged file based on the encrypted file.

7. The method according to claim 6, wherein the step of encrypting the at least one target file to generate the corresponding encrypted file comprises:
acquiring encryption information, wherein the encryption information represents a rule for randomly encrypting the target file;
randomly encrypting the file information of the at least one target file to generate corresponding encrypted data based on the encryption information; and
filling the encrypted data into a corresponding target file to generate the encrypted file.

8. The method according to claim 7, wherein before the step of randomly encrypting the at least one target file to generate the corresponding encrypted file based on the encryption information, the method further comprises:
acquiring a first data length of the at least one target file and a preset second data length;
calculating a first encryption number of times required for encrypting the first data length and a second encryption number of times required for encrypting the second data length; and
determining a smaller one of the first encryption number of times and the second encryption number of times to be a target encryption number of times, and generating the encryption information based on the target encryption number of times.

9. The method according to claim 7, wherein after the step of randomly encrypting the at least one target file to generate the corresponding encrypted file based on the encryption information, the method further comprises:
sending the encryption information to the second application; and
the step of generating the corresponding merged file based on the encrypted file comprises:
combining the encrypted file with other unencrypted target files to generate the merged file.

10. The method according to claim 1, wherein the step of loading the temporary file by means of the second application to obtain the target data, comprises:
when the second application runs in the foreground, reading the system clipboard to obtain the temporary file; and
acquiring the encrypted file corresponding to the temporary file, and restoring the temporary file based on the encrypted file to obtain the target data.

11. (canceled)

12. An electronic device, comprising: a processor, and a memory in communication connection with the processor;
the memory stores computer execution instructions; and
the processor executes the computer execution instructions stored in the memory to cause the electronic device to:
acquire target data in response to a data replication instruction for a first application in a target operating system, wherein the first application is in data isolation with a second application in the target operating system;
load the target data to a system clipboard to generate a temporary file; and
load the temporary file by means of the second application to obtain the target data, and executing a target function corresponding to the second application based on the target data.

13. A non-transitory computer-readable storage medium, wherein
computer execution instructions are stored in the computer-readable storage medium, the computer execution instructions, when being executed by a processor, cause the processor to:
acquire target data in response to a data replication instruction for a first application in a target operating system, wherein the first application is in data isolation with a second application in the target operating system;
load the target data to a system clipboard to generate a temporary file; and
load the temporary file by means of the second application to obtain the target data, and executing a target function corresponding to the second application based on the target data.

14. (canceled)

15. The electronic device according to claim 12, wherein the target data comprises at least two target files; the electronic device being caused to load the target data to the system clipboard to generate the temporary file comprises being caused to:
merge the at least two target files to generate at least one merged file; and
invoke the system clipboard to load the at least one merged file to generate the temporary file.

16. The electronic device according to claim 15, wherein the electronic device being caused to merge the at least two target files to generate the at least one merged file comprises being caused to:
acquire file information of the at least two target files, wherein the file information comprises storage addresses of the target files;
perform logical address merging based on the storage addresses corresponding to the at least two target files to obtain merged file information, wherein the merged file information represents a storage address of the merged file; and
the electronic device being caused to invoke the system clipboard to load the at least one merged file to generate the temporary file comprises being caused to:
invoke the system clipboard to perform file loading process based on the merged file information to generate the temporary file.

17. The electronic device according to claim 15, wherein the electronic device being caused to merge the at least two target files to generate the at least one merged file comprises being caused to:
acquire a data length of each of the target files; and
sequentially merge the target files based on the data length of each of the target files and a preset merging length to generate the at least one merged file, wherein the data length of the merged file is less than or equal to the merging length.

18. The electronic device according to claim 15, wherein a target file comprises a media file and an editing file corresponding to the media file, and the editing file represents content for editing the media file.

19. The electronic device according to claim 15, wherein the electronic device being caused to merge the at least two target files to generate the at least one merged file comprises being caused to:
encrypt at least one target file to generate a corresponding encrypted file; and
generate the corresponding merged file based on the encrypted file.

20. The electronic device according to claim 19, wherein the electronic device being caused to encrypt the at least one target file to generate the corresponding encrypted file comprises being caused to:
acquire encryption information, wherein the encryption information represents a rule for randomly encrypting the target file;
randomly encrypt the file information of the at least one target file to generate corresponding encrypted data based on the encryption information; and
fill the encrypted data into a corresponding target file to generate the encrypted file.

21. The electronic device according to claim 20, wherein before the electronic device being randomly encrypting the at least one target file to generate the corresponding encrypted file based on the encryption information, the electronic device is further caused to:
acquire a first data length of the at least one target file and a preset second data length;
calculate a first encryption number of times required for encrypting the first data length and a second encryption number of times required for encrypting the second data length; and
determine a smaller one of the first encryption number of times and the second encryption number of times to be a target encryption number of times, and generating the encryption information based on the target encryption number of times.

22. The electronic device according to claim 12, wherein the electronic device being caused to load the temporary file by means of the second application to obtain the target data comprises being caused to:
read the system clipboard to obtain the temporary file when the second application runs in the foreground; and
acquire the encrypted file corresponding to the temporary file, and restoring the temporary file based on the encrypted file to obtain the target data.
